(19) United States
(12) Patent Application Publication
(10) Pub. No.: US 2008/0080962 A1
(43) Pub. Date: Apr. 3, 2008

(54) METHOD AND TRANSPORT DEVICE FOR TRANSPORTING OBJECTS

(76) Inventor: Gerhard Holtmeier, Luebeck (DE)

Correspondence Address: Striker, Striker & Stenby, 103 East Neck Road, Huntington, NY, 11743, US

(21) Appl. No.: 11/859,869

(22) Filed: Sep. 24, 2007

(30) Foreign Application Priority Data
Sep. 29, 2006 (DE) 10 2006 046 624.1

(51) Int. Cl. B65G 47/91

(52) U.S. Cl. 414/627

(57) ABSTRACT

In a method and a transport device for transporting objects, limp objects in particular, such as carbon fiber mats or the like, a holding surface of a holding unit for holding the objects includes several holding elements, and the disadvantages of the related art are avoided or at least greatly reduced. A central actuating unit actuates and not actuates all holding elements. It is possible to realize a centrally actuated selection of the holding elements that is carried out as a function of the shape and/or dimensions of the object to be held.

### CROSS-REFERENCE TO A RELATED APPLICATION

The invention described and claimed hereinbelow is also described in German Patent Application DE 10 2006 046 624.1 filed on Sep. 29, 2006. This German Patent Application, whose subject matter is incorporated here by reference, provides the basis for a claim of priority of invention under 35 U.S.C. 119(a)-(d).

### BACKGROUND OF THE INVENTION

The present invention relates to a method and a transport device for transporting objects, limp components in particular, such as carbon fiber mats or the like.

In industrial working processes, objects are very often transported from one site to another, e.g., to perform highly diverse working steps on these objects.

When limp components are used, such as carbon fiber mats or the like, for the construction of airplanes, automobiles, ships, etc., special requirements are placed on the transport systems, primarily when relatively large components are used, due to the resilience and extreme deformability of the components. Carbon mats of these types are generally hardened using known additives, to give them a defined shape and/or stiffness for the particular application. Carbon fiber mats of this type or the like are often also used for composite materials.

Mainly, these mats are particularly difficult to handle before they are hardened. Transport and conveyance devices for this purpose are already known. They pick up and move objects of this type using suction grippers, for instance.

Gripper systems and suction systems composed of a large number of individual holding and suction elements are already known for use with relatively large components for, e.g., airplane wings, ship hulls, or the like.

The numerous suction elements and/or the entire holding surface realized therewith have typically been adapted to conform with the related component or its geometry, so that the holding surface essentially conforms to the surface of one side of the component. The disadvantage of this, however, is that highly diverse holding systems with related holding elements must also be used for highly diverse components and objects. This results in relatively high operating costs and loss of time, since the holding systems must be switched out when different objects are to be handled.

It is also known to use a holding system with a relatively large holding surface, in which case the holding surface is markedly larger than the corresponding surface or contour of the component. As a result, however, after the object or the component is cut out of or separated from a larger piece—a material roll, etc., in particular—the trimmings located around the component required—and sometimes a second component as well—is/are also gripped and/or picked up using suction. This not desired, however, thereby making holding systems of this type with large surface areas unsuitable for these applications.

### SUMMARY OF THE INVENTION

The object of the present invention, therefore, is to provide a method and a transport device for transporting objects, limp objects in particular, such as carbon fiber mats or the like, with which the disadvantages of the related art are avoided or at least greatly reduced.

An inventive method and an inventive transport device are characterized by the fact that a central actuating unit for actuating and not actuating all holding elements is provided, and it is possible to realize a centrally actuated selection of the holding elements that is carried out as a function of the shape and/or dimensions of the object to be held. Every holding element may therefore be held individually or separately, or it may be not actuated, in a defined manner.

According to the present invention, it is therefore possible to separate the detached or cut-out object from the material remaining around it. The remaining material may be waste material and/or further objects, which may be detached and/or cut out collectively in a single working step. New applications are therefore made possible according to the present invention.

Using the present invention, e.g., a single transport and holding system may be used for highly diverse objects or components having different geometries or contours. The central actuating unit thereby ensures that, depending on the shape and dimensions of the object to be gripped or held, only those holding elements grip the object that are located within its contour. Accordingly, remaining material or waste, e.g., roll material, located directly next to the object is not gripped. This results in an advantageous detachment of the object of interest for processing or further processing from, e.g., remaining material or waste to be discarded. The remaining material or waste of the original piece may be removed in any manner, e.g., from the point where the related working step was carried out.

The holding elements may be designed, e.g., as contactless grippers or swinging holding elements, in particular for generating acoustic waves or levitation waves, according to publication DE 101 21 742.

The holding elements are preferably designed as suction elements with a suction fluid to which pressure may be applied, to hold the objects with suction. It has been shown in practice that a particularly advantageous manner of gripping and further-transporting objects—limp components such as carbon fiber mats or the like, in particular—may be accomplished primarily by using suction grippers or suction elements. Gas or air are preferably used as the suction fluid. Air is easy to handle, and it is neutral relative to the objects to be handled.

In an advantageous variant of the present invention, the holding surface of the holding unit is designed essentially as a planar holding surface, in the resting state at least. A holding surface that is advantageously designed in this manner is of particularly advantage mainly for carbon fiber mats, etc., that have not yet hardened.

As an alternative to the variant presented above, the holding surface may be designed essentially as a curved surface, particularly as a cylindrical surface, when in the resting state. With the aid of a holding surface advantageously designed in this manner, it is possible to roughly or, possibly, exactly conform the three-dimensional shape of the holding surface to the three-dimensional shape of the object to be held. The holding force or the holding of objects may therefore be optimized.

With a holding surface that is curved or that has a cylindrical surface, it is also possible to roll up, e.g., relatively long objects, completely or at least partially. For example, the transport device according to the present invention is designed such that the holding unit is rotatable in particular around at least one axis of rotation, preferably by approximately 180° or 306°, or more than one or several rotations.

The holding unit may also be located on an advantageous handling system, so that the holding unit may perform a rotating and/or linear motion. Related robotic arms, handling systems, or the like, which are already in use in multiple applications, may be used for this purpose, for example.

With an advantageous transport device of this type, it is possible to position the holding unit initially at a narrow end of the object or component to be rolled up, and to then grip or hold the component or object. In particular, the suction elements located inside the contour of the object are activated. Next, e.g., the holding unit or the cylindrical roll-up gripper may be advantageously displaced or moved in the longitudinal direction of the object, preferably synchronously with its roll-up motion or rotational motion. As a result, the object is rolled up on the holding unit or the roll-up gripper without undergoing stress or deformation.

This is of particular advantage primarily with fiber mats and fabrics such as carbon fiber mats or the like, to prevent the individual fibers from becoming displaced, and to prevent deformation. The object may be transported—according to the present invention—from one site to another in a manner such that its shape is retained. The improved accuracy of shape that is realized therefore results in improved quality of the products to be manufactured out of the objects that are transported.

The holding elements are preferably designed to be displaceable transversely to the holding surface using at least one displacing unit. In particular, a separate displacing unit is assigned to each holding element. Using a displacing unit or numerous displacing units of this type, it is possible to advantageously conform—three-dimensionally, in particular—to the shape of the object to be transported. This is of particular significance with dimensionally stable and curved objects in particular, such as hardened carbon fiber mats or the like.

The displacing unit performs, e.g., linear displacement and/or transverse displacement relative to the holding surface of the holding element. Hydraulic or pneumatic piston cylinder systems are optionally provided for this purpose. Spring systems, helical spring systems in particular, are preferably provided as the displacing unit. The advantage of spring systems of this type is, e.g., that, when relatively dimensionally stable objects are involved, the spring systems may conform—essentially automatically—to the shape of the objects to be transported, when the proper amount of contact pressure is applied. This is advantageous with suction elements and suction systems in particular.

It is particularly advantageous that the holding elements may be displaced transversely to the holding surface, even when curved holding surfaces or holding units designed as a cylindrical surface are involved. For example, to set down and/or temporarily store objects or limp components that have been rolled up accordingly, the numerous holding elements are displaced or retracted in the direction toward the axis of rotation such that the rolled-up object or the roll may be easily released. The holding unit may then be drawn out of this rolled-up object or roll. The object or the roll may therefore be placed in temporary storage or set down, e.g., in a storage compartment or the like, without undergoing any change or displacement of shape in particular.

As needed, and in the reverse order, an object that has been rolled up in this manner, or a roll, may also be picked up by a gripper or holding unit designed in the manner described above and transported further. To this end, the holding elements are advantageously retracted again and displaced in the direction toward of the axis of rotation, so that the holding unit may be inserted into the rolled-up object or the roll, without touching the roll.

The holding elements are then displaced or spread out in the direction of the roll with the larger diameter, thereby enabling it to be held in an advantageous manner and transported to its site of use, without its undergoing any change or displacement of shape in particular.

To set down or release the rolled-up objects or rolls, they may be placed with the narrow end at the set-down location or at an end of the set-down location, and—preferably with a synchronous, linear displacement or movement of the holding unit, combined with a rotary motion—they may be unrolled or placed in a related mould or the like, without their undergoing any change or displacement of shape in particular. In this mould, e.g., the limp carbon fiber mats or the like may be hardened.

Basically, with fiber mats or fabrics of this type, for example, which have been advantageously rolled up onto a cylindrical holding system, it is ensured that the object or the mat does not become deformed when it is rolled up, stored temporarily, or set down. As a result, the quality of the object or mat being transported is not affected, thereby ensuring that a particularly high dimensional stability of the final product is attained.

Unlike an advantageous roll-up system of this type, holding systems that are relatively long and essentially planar—and therefore difficult to handle—have been used in the related art. Particularly long objects are often used in airplane construction, etc.

Advantageously, the central actuating unit is designed as an electronic control unit for controlling the individual holding elements. In particular, the holding elements to be actuated are actuated using electronic data on the object, and the holding elements not to be actuated are not actuated. Valves or the like for the suction fluid are preferably designed as actuating components to be actuated electronically. An advantageous electronic control of the holding elements may be realized at much less cost, e.g., as a hydraulic or pneumatic control of the holding elements.

Furthermore, with this variant of the present invention, the electronic design data on the objects—which are generally already available—may be used directly to actuate or to not actuate the holding elements. The control of the holding elements is simplified accordingly.

In general, according to the present invention, the manufacture of carbon fiber components, e.g., for airplanes, automobiles or the like, using carbon fiber mats as strengthening pieces, may be advantageously handled and transported. Strengthening pieces of this type are often cut—in the exact shape—out of roll material, e.g., on a cutting table or the like. A laser cutting method, a punching method or the like is advantageously used for this purpose. The cut-out components and, around them, any remaining material or the waste material remain on the cutting table.

According to the present invention, a further-processing procedure that is automated to the greatest extent possible may now be realized, in which the cut-out components are removed from the cutting table in a targeted manner, and having been separated from the waste. This may take place using, e.g., suction grippers, etc., which suction-up the limp component with a slight vacuum, hold it, and transport it away. For example, an advantageous portal industrial robot or other known handling systems may place suction grippers of this type over the component, lift the component away from the waste, and place it, e.g., in a temporary storage location or transport it away directly for further use.

Via this targeted actuation and non-actuation of individual holding elements or segments of the holding unit, an adaptation to the component size and shape is realized, preferably using the CAD data record of the component. This data record, which may also be used to perform cutting on the cutting table, may define the switching on and off of the suction segments that are required or that are not required, in a manner according to the present invention.

The main advantage of the inventive method is that it becomes unnecessary to replace the holding unit often, that is, according to the present invention, a single holding element may be used for highly diverse components and objects.

### BRIEF DESCRIPTION OF THE DRAWINGS

FIG. 1 shows a schematic, perspective view of a segmented suction unit according to the present invention,

FIG. 2 shows a schematic underside view of the suction unit in FIG. 1,

FIG. 3 shows a schematic, perspective view of a roll-up suction gripper according to the present invention, and

FIG. 4 shows a schematic, perspective view of a production line with inventive holding systems.

### DESCRIPTION OF THE PREFERRED EMBODIMENTS

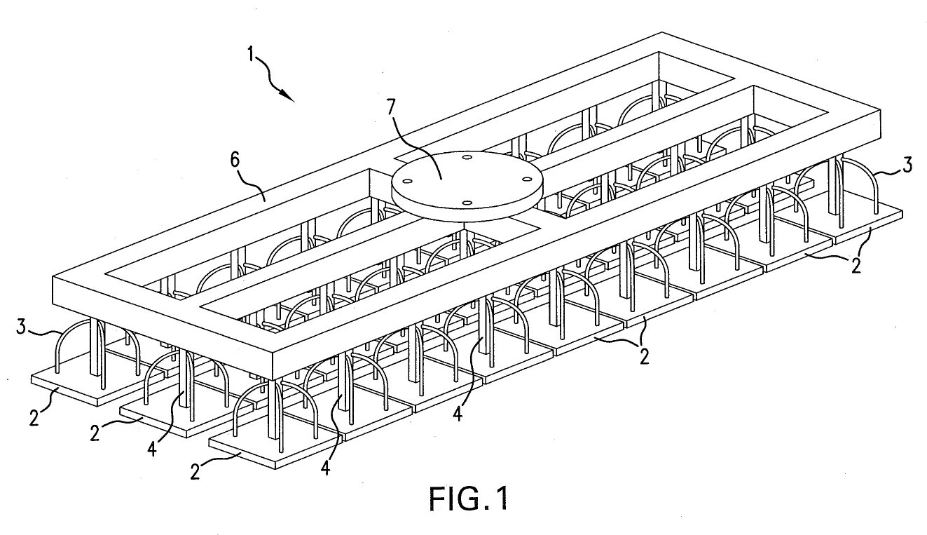

A perspective view of a suction gripper 1 with numerous suction plates 2 is shown in FIG. 1. Suction plates 2 are acted upon with vacuum using vacuum tubes 3.

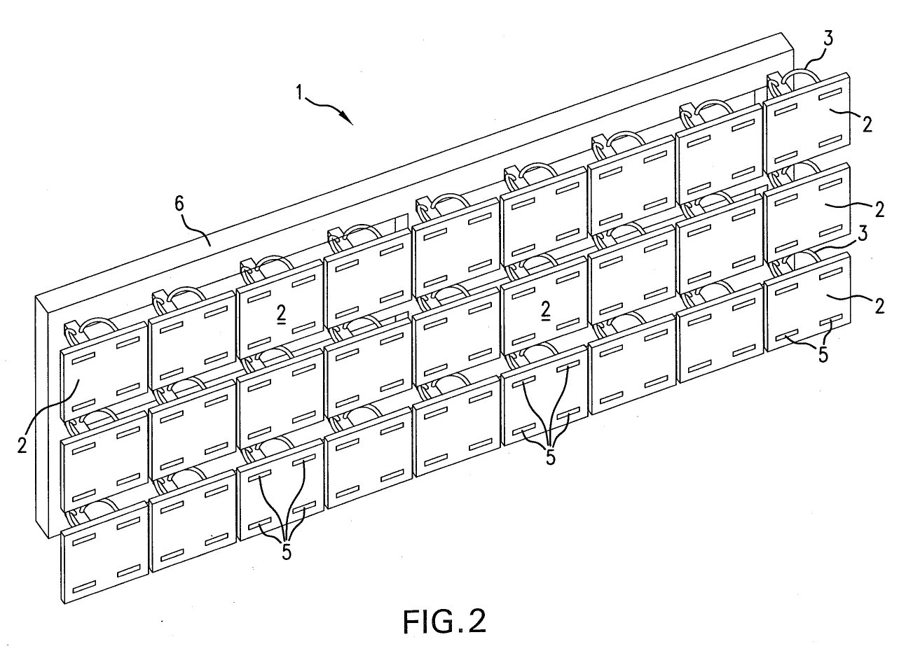

FIG. 2 shows the design of the underside of suction gripper 1 and suction plates 2. In the exemplary embodiment shown, each suction plate 2 includes four suction pockets 5, each of which is advantageously covered with a grid or the like. This prevents dirt particles, etc., from entering the vacuum system.

FIG. 1 shows, in particular, that suction plates 2 are connected with a frame 6 using torsion bars 4. Torsion bars 4 make it possible, in particular, to displace suction plates 2 in the direction toward frame 6, and to displace them transversely to the longitudinal axis of torsion bar 4. It is therefore possible to adapt the shape to three-dimensional objects and components.

Frame 6 includes a plate 7, which is provided for connection to a handling system or a robotic arm or the like. Handling systems and robotic arms of this type have been commonplace in industrial manufacturing systems for a long time. They advantageously make it possible, in particular, to displace suction gripper 1 in the X and/or Y and/or Z direction. In addition, using available handling systems and/or robotic arms of this type, or the like, it is possible to realize a rotation around up to three axes of rotation (oriented orthogonally to each other), thereby resulting in a total of six degrees of freedom.

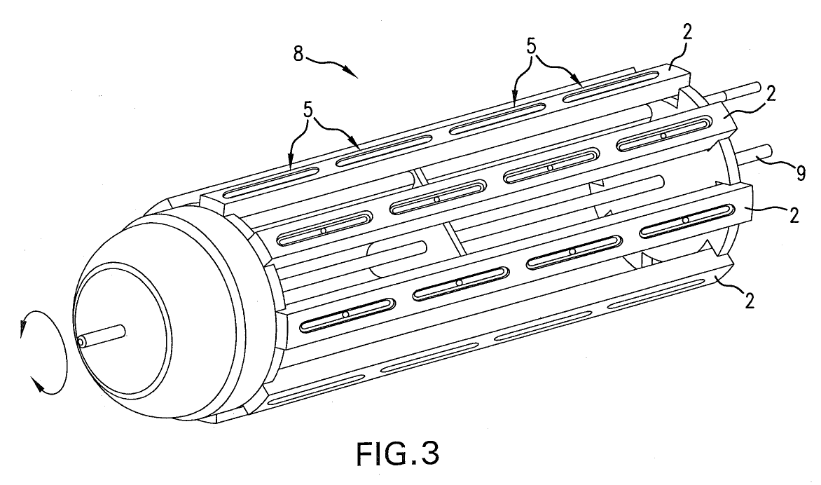

A roll-up gripper is depicted schematically in FIG. 3. Roll-up gripper 8 is rotatable around an axis of rotation 9. According to the present invention, roll-up gripper 8 also includes several and/or numerous suction plates 2, each of which includes four suction pockets 5 in the exemplary embodiment shown. Vacuum tubes 3 are intentionally not shown in FIG. 3, to keep the illustration simple. Accordingly, the depiction in FIG. 3 also does not show the depiction of a connection—as described above, for example—with a handling system or a robotic arm or the like.

With the aid of a roll-up gripper of this type, e.g., a particularly long component, such as a carbon fiber mat, may be rolled onto roll-up gripper 8, e.g., via rotation around axis of rotation 9.

To prevent deformation of the component or fiber mat when it is rolled up, roll-up gripper 8 is located, e.g., at a narrow end of the component, and related suction plate 2 or only individual suction pockets 5 are activated, so that the component is advantageously fixed in place on roll-up gripper 8. Next, the component may be advantageously rolled onto roll-up gripper 8 via rotation around axis of rotation 9 and via linear displacement of roll-up gripper 8 along the component.

With fiber mats or the like, through which a fluid or air may flow at least partially, it is feasible that the fiber mats may be placed on a single roll-up gripper 8 in several layers.

Using a roll-up gripper 8 of this type, long components and/or fiber mats, in particular, may be transported and placed in interim storage, if necessary, in a very space-saving manner.

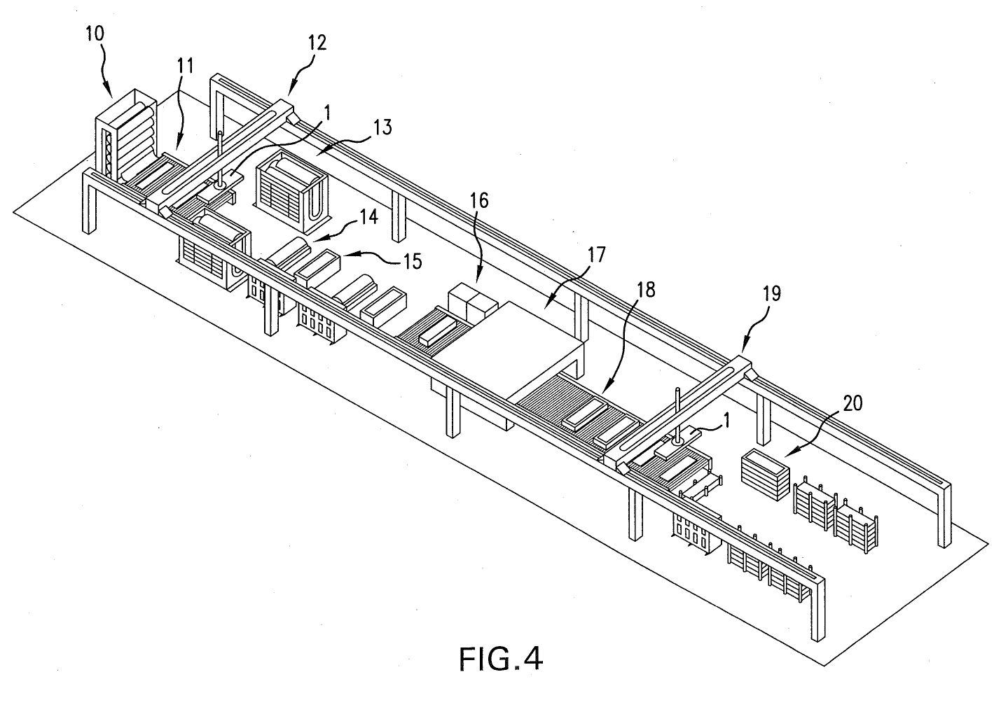

FIG. 4 is a schematic depiction of a related production line for limp components such as carbon fiber mats, etc. Rolls—carbon fiber rolls, in particular—are stored, e.g., in a roll paternoster 10 with an unrolling system. Using this unrolling system, the mats are unrolled such that they may be located on a cutting table 11.

On cutting table 11, the desired component or the desired shape are cut out or separated out, e.g., using a laser-cutting method, a punching method, or the like. The desired component is then gripped using a handling portal 12 with suction gripper 1 or a roll-up gripper 8, and it is transported separately from the roll or the waste, e.g., to a trimming store 13. The remainding material and/or waste from the fiber mat is pushed, e.g., into a waste container, although this is not depicted.

Using suction gripper 1, the component is transported from trimming store 13 to a moulding block 14. Moulding block 14 has a mould 15 with a three-dimensional or curved shape, for example.

In a vacuum station 16, the fiber mats are impregnated with resin. Moulding block 14 with the fiber mat and resin is then heated in an oven 17, and hardening takes place. At removal station 18, it is ensured that the resin has hardened completely. Using a handling portal 19 for the moulds, the hardened fiber mat is gripped separatedly using a suction gripper 1 and transported, e.g., to moulded-product storage 20. From this point forward, the component is processed further.

It will be understood that each of the elements described above, or two or more together, may also find a useful application in other types of methods and constructions differing from the type described above.

While the invention has been illustrated and described as embodied in a method and transport device for transporting objects, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A transport device for transporting objects, comprising a holding unit having a holding surface including a plurality of holding elements for holding the objects; and a central actuating unit configured for actuating and not actuating all said holding elements so as to realize a centrally actuated selection of said holding elements that is carried out as a function of a parameter selected from the group consisting of a shape of an object to be held, dimensions of an object to be held, and both.

2. A transport device as defined in claim 1, wherein said holding elements are configured as suction elements with a suction fluid to which a pressure is applicable, to hold the objects with suction.

3. A transport device as defined in claim 1, wherein said holding surface is configured substantially as a planar holding surface, at least in a resting state.

4. A transport device as defined in claim 1, wherein said holding device is configured substantially as a curved holding surface at least in a resting state.

5. A transport device as defined in claim 1, wherein said holding surface is configured substantially as a cylindrical surface at least in a resting state.

6. A transport device as defined in claim 1, wherein said holding elements are displaceable transversely to said holding surface; and further comprising at least one displacing unit for displacing said holding elements.

7. A transport device as defined in claim 1, wherein said holding elements are displaceable transversley to said holding surface; and further comprising a separate displacing unit assigned to each of said holding elements.

8. A transport device as defined in claim 1, wherein said central actuating unit is configured as an electronic control unit for controlling individual ones of said holding elements.

9. A transport device as defined in claim 1, wherein said central actuating unit is configured to use electronic data for actuating said holding elements, and does not actuate those of said holding elements not to be actuated.

10. A transport device as defined in claim 1, wherein said transport device is configured to transport an object, which is at least partly surrounded by a material remaining from an original piece.

11. A transport device as defined in claim 1, wherein the transport device is configured for transporting limp components.

12. A transport device as defined in claim 1, wherein said transport device is configured for transporting limp components which are carbon fiber mats.

13. A method for transporting objects, comprising the steps of holding objects by a plurality of holding elements included in a holding surface of a holding unit; actuating and not actuating all the holding elements by a central actuating unit; and realizing a centrally actuated selection of the holding elements that is carried out as a function of a parameter selected from the group consisting of a shape of an object to be held, dimensions of an object, and both.

14. A method as defined in claim 13, wherein said holding includes holding at least one object which is separated from an original piece so that material remaining from the original piece encloses at least a portion of the object, said selecting including centrally actuated selecting the holding elements so as to enable the separated object to be transported away from a side where the separation was carried out, while the material remaining from the original piece remains at the side where the separation was carried out.

15. A method as defined in claim 13, wherein said holding includes holding the at least one object which is separated from an original piece by cutting out.
